(19) United States
(12) Patent Application Publication
(10) Pub. No.: US 2015/0066366 A1
(43) Pub. Date: Mar. 5, 2015

(54) PARTIAL MAP UPDATES

(71) Applicant: QOROS AUTOMOTIVE CO., LTD., Changshu, Jiangsu (CN)

(72) Inventors: Eric Hc Pang, Changshu (CN); Stefano Villanti, Changshu (CN)

(21) Appl. No.: 14/385,751

(22) PCT Filed: Mar. 16, 2012
(86) PCT No.: PCT/CN2012/072469

§ 371 Date: Sep. 16, 2014

(51) Int. Cl. G01C 21/34; G06Q 20/12

(52) U.S. Cl. CPC G01C 21/34; G06Q 20/123
USPC 701/532

(57) ABSTRACT

A method, implemented in a computer system, may comprise maintaining by the computer system map data divided into at least a first pre-selected map portion and a second pre-selected map portion different from the first pre-selected map portion. The computer system may receive a request for transmission of the first pre-selected map portion to a vehicle navigation unit, and transmit a payment request indicating a payment amount associated with the first pre-selected map portion. The computer system may also receive an indication of payment of the payment amount, and transmit over a wireless network the first pre-selected map portion to the vehicle navigation unit.

### BACKGROUND

Embodiments of the present disclosure relate to the field of navigation systems, and in particular to vehicular navigation systems that display maps and/or other data.

Vehicles such as automobiles, boats, and aircraft travel from point to point by land, water, or air. Safe and efficient travel includes keeping track of the vehicle's location and directing it toward a destination. Navigation may include the use of maps that represent the territory being crossed and potential routes. Navigation may include the use of electronic systems that display digital maps. An electronic navigation system may store all or part of the map data, which may become out of date as a result of changes in the mapped territory. A navigation system may occasionally update its map data.

### SUMMARY

One or more embodiments of the present disclosure may include methods, systems, and computer program products for updating electronic maps. According to an embodiment of the present disclosure, a method, implemented in a computer system, may comprise maintaining by the computer system map data divided into at least a first pre-selected map portion and a second pre-selected map portion different from the first pre-selected map portion. The computer system may receive a request for transmission of the first pre-selected map portion associated with a vehicle navigation unit, and transmit a payment request indicating a payment amount associated with the first pre-selected map portion. The computer system may also receive an indication of payment of the payment amount, and transmit over a wireless network the first pre-selected map portion to the vehicle navigation unit.

According to an embodiment of the present disclosure, a system for updating electronic maps may comprise a first computer system, a second computer system, and a vehicle navigation unit. The first computer system may include a first processor; a first memory; and a first data manipulation program with a plurality of instructions stored in the first memory. The instructions of the first computer system may be executed by the first processor to cause the first processor to provide map data divided into at least a first pre-selected map portion and a second pre-selected map portion different from the first pre-selected map portion, receive a request for transmission of the first pre-selected map portion, transmit a payment request indicating a payment amount associated with the first pre-selected map portion, receive an indication of payment of the payment amount, and transmit the first pre-selected map portion. The second computer system may be remote from the first computer system and include a second processor; a second memory; and a second data manipulation program with a plurality of instructions stored in the second memory that may be executed by the second processor to cause the second processor to transmit to the first computer system the request for transmission of the first pre-selected map portion, and transmit to the first computer system the payment amount in response to the payment request. The vehicle navigation unit may include a third processor; a third memory; and a third data manipulation program with instructions stored in the third memory that may be executed by the third processor to cause the third processor to receive the transmission of the first pre-selected map portion from the first computer system.

According to an embodiment of the present disclosure, a method, implemented in a vehicle navigation system, may comprise automatically transmitting from a first location a request for transmission of a first pre-selected map portion associated with map data for a first geographic region, automatically initiating payment of a first payment amount associated with the first pre-selected map portion, and receiving the first pre-selected map portion after the first payment amount is paid.

### BRIEF DESCRIPTION OF THE DRAWINGS

In order that the present disclosure will be readily understood, a more particular description will be rendered by reference to specific embodiments that are illustrated in the appended drawings. Understanding that these drawings depict only typical embodiments of the disclosure and are not therefore to be considered to be limiting of its scope, methods and systems will be described and explained with additional specificity and detail through the use of the accompanying drawings, in which:

FIG. 1 depicts a representative client-server computer network in which illustrative embodiments may be implemented.

FIG. 2 shows a block diagram of a data processing system in which illustrative embodiments may be implemented.

FIG. 3 depicts a representative telematics and/or navigation system in which illustrative embodiments may be implemented.

FIG. 4 shows a block diagram of a navigation unit in which illustrative embodiments may be implemented.

FIG. 5 shows a representation of digital map data divided into one or more portions in accordance with the principles of the present disclosure.

FIG. 6 shows an embodiment of a transaction between a navigation unit and a telematics server in accordance with the principles of the present disclosure.

FIG. 7 shows an embodiment of a transaction between a client computer, telematics server, and navigation unit in accordance with the principles of the present disclosure.

FIG. 8 shows an example of a method according to an embodiment of the present disclosure.

FIG. 9 shows an example of a method according to an embodiment of the present disclosure.

### DETAILED DESCRIPTION

As will be appreciated by one skilled in the art, the present disclosure may be embodied as a system, method, or computer program product. Accordingly, the disclosure may take the form of an entirely hardware embodiment, an entirely software embodiment (including firmware, resident software, and/or micro-code, etc.), or an embodiment combining software and hardware aspects that may all generally be referred to herein as a “circuit,” “module,” or “system.” Furthermore, the disclosure may take the form of a computer program product embodied in any tangible medium of expression having computer-usable program code embodied in the medium.

Any combination of one or more computer-usable or computer-readable medium(s) may be utilized. The computer-usable or computer-readable medium may be, for example but not limited to, an electronic, magnetic, optical, electromagnetic, infrared, or semiconductor system, apparatus, device, or propagation medium. More specific examples of a computer-readable medium may include the following: an electrical connection having one or more conductors (e.g., wires), a portable computer diskette, a hard disk, a random access memory (RAM), a read-only memory (ROM), an erasable programmable read-only memory (EPROM or Flash memory), an optical fiber, a portable compact disc read-only memory (CDROM), an optical storage device, a transmission media such as those supporting the Internet or an intranet, or a magnetic storage device.

The computer-usable or computer-readable medium can be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of the present disclosure, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer-usable program code may be transmitted using any appropriate medium, including but not limited to wireless, wireline, optical fiber cable, or RF.

Computer program code for carrying out operations of the embodiments of the disclosure may be written in any combination of one or more programming languages, including an object-oriented programming language such as Java, Smalltalk, C++ or the like and conventional procedural programming languages, such as the C programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN), a wide area network (WAN), a mobile communications network, and/or other types of wired or wireless networks, or the connection may be made to an external computer (for example, through the Internet using an Internet Service Provider).

The aspects of the disclosure are described below with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions.

These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions and/or acts specified in the flowchart and/or block diagram block or blocks.

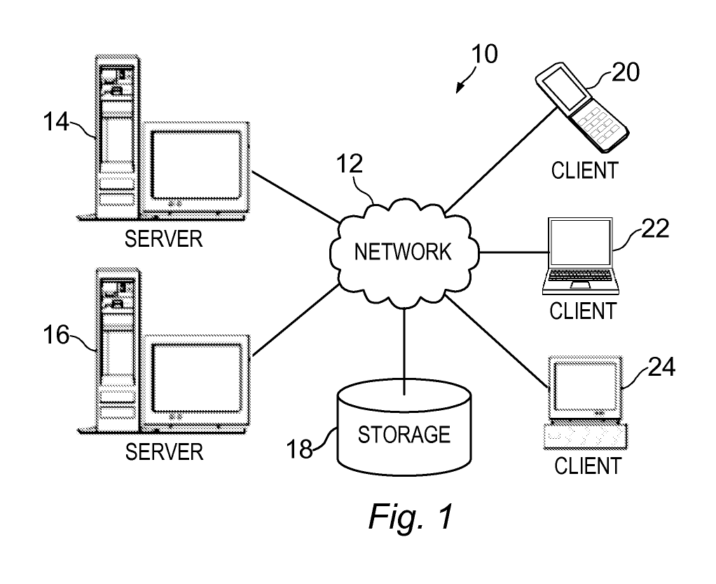

With reference now to the figures, and in particular with reference to FIG. 1, a diagram of a data processing environment is provided in which illustrative embodiments may be implemented. It should be appreciated that FIG. 1 is provided only as an illustration of one implementation and is not intended to imply any limitation with regard to the environments in which different embodiments may be implemented. Many modifications to the depicted environments may be made.

FIG. 1 depicts a pictorial representation of a distributed data processing system in which illustrative embodiments may be implemented. Network data processing system 10 is a network of computers in which the illustrative embodiments may be implemented. Network data processing system 10 contains network 12, which is the medium used to provide communications links between various devices and computers connected together within network data processing system 10. Network 12 may include connections, such as wire, wireless communication links, and/or fiber optic cables, or the like.

In the depicted example, server computer 14 and server computer 16 connect to network 12 along with storage unit 18. In addition, client computers 20, 22, and 24 connect to network 12. Client computers 20, 22, and 24 may be, for example, personal computers, network computers, or mobile computing devices such as personal digital assistants (PDAs), cell phones, handheld gaming devices, or tablet computers and the like. Client computers 20, 22, and 24 may also be a computer or any computing device associated with a vehicle, such as a telematics and/or navigation unit. In the depicted example, server computer 14 provides information, such as boot files, operating system images, and applications to client computers 20, 22, and 24. Client computers 20, 22, and 24 are clients to server computer 14 in this example. Network data processing system 10 may include additional server computers, client computers, and other devices not shown.

Program code located in network data processing system 10 may be stored on a computer recordable storage medium and downloaded to a data processing system or other device for use. For example, program code may be stored on a computer recordable storage medium on server computer 14 and downloaded to client computer 20 over network 12 for use on client computer 20.

In the depicted example, network data processing system 10 may be the Internet with network 12 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, comprising thousands of commercial, governmental, educational, and other computer systems that route data and messages. Network data processing system 10 also may be implemented as a number of different types of networks, such as for example, an intranet, a local area network (LAN), a wide area network (WAN), a mobile communications network, and/or other types of wired or wireless networks. FIG. 1 is intended as an example, and not as an architectural limitation for the different illustrative embodiments.

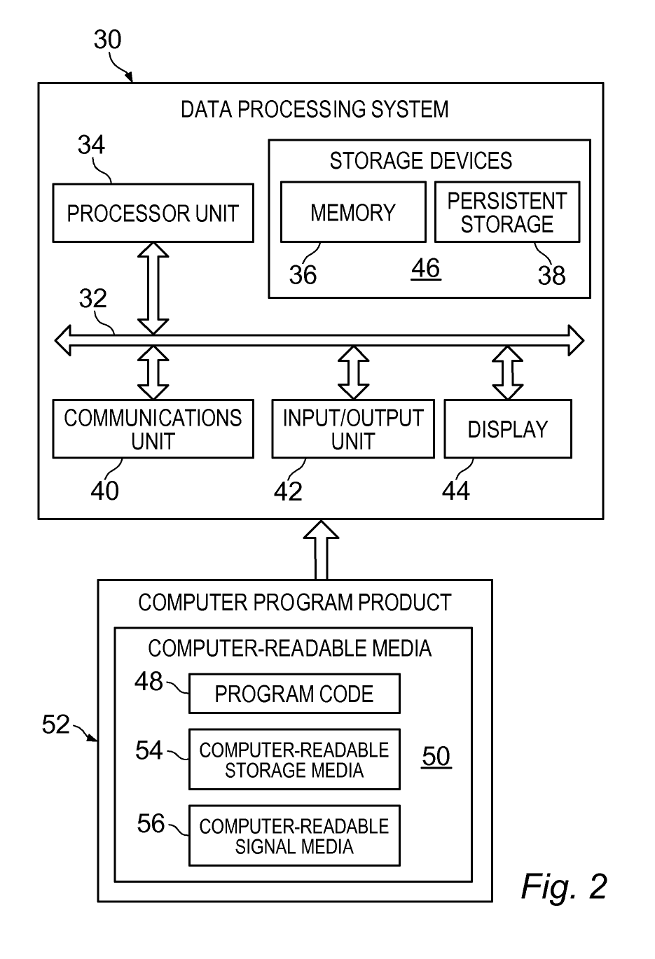

Turning now to FIG. 2, a block diagram of a data processing system is depicted in accordance with the present disclosure. In this illustrative example, data processing system 30 includes communications fabric 32, which provides communications between processor unit 34, memory 36, persistent storage 38, communications unit 40, input/output (I/O) unit 42, and display 44.

Processor unit 34 serves to execute instructions for software that may be loaded into memory 36. Processor unit 34 may be a number of processors, a multi-processor core, or some other type of processor, depending on the particular implementation. A number, as used herein with reference to an item, means one or more items. Further, processor unit 34 may be implemented using a number of heterogeneous processor systems in which a main processor is present with secondary processors on a single chip. As another illustrative example, processor unit 34 may be a symmetric multi-processor system containing multiple processors of the same type.

Memory 36 and persistent storage 38 are examples of storage devices 46. A storage device is any piece of hardware that is capable of storing information, such as, for example, without limitation, data, program code in functional form, and/or other suitable information on either a temporary basis and/or a permanent basis. Memory 36, in these examples, may be, for example, a random access memory or any other suitable volatile or non-volatile storage device. Persistent storage 38 may take various forms, depending on the particular implementation.

For example, persistent storage 38 may contain one or more components or devices such as a hard drive, a flash memory, a rewritable optical disk, a rewritable magnetic tape, or some combination of the above. The media used by persistent storage 38 also may be removable. For example, a removable hard drive may be used for persistent storage 38.

Communications unit 40, in these examples, provides for communications with other data processing systems or devices. In these examples, communications unit 40 may be a network interface card. Communications unit 40 may provide communications through the use of either or both physical and wireless communications links.

Input/output unit 42 allows for input and output of data with other devices that may be connected to data processing system 30. For example, input/output unit 42 may provide a connection for user input through a keyboard, a mouse, and/or some other suitable input device. Further, input/output unit 42 may send output to a printer. Display 44 provides a mechanism to display information to a user.

Instructions for the operating system, applications, and/or programs may be located in storage devices 46, which are in communication with processor unit 34 through communications fabric 32. In these illustrative examples, the instructions can be in a functional form on persistent storage 38. These instructions may be loaded into memory 36 for execution by processor unit 34. The processes of the different embodiments may be performed by processor unit 34 using computer implemented instructions, which may be located in a memory, such as memory 36.

These instructions are referred to as program code, computer-usable program code, or computer-readable program code that may be read and executed by a processor in processor unit 34. The program code in the different embodiments may be embodied on different physical or computer-readable storage media, such as memory 36 or persistent storage 38.

Program code 48 can be located in a functional form on computer-readable media 50 that is selectively removable and may be loaded onto or transferred to data processing system 30 for execution by processor unit 34. Program code 48 and computer-readable media 50 form computer program product 52 in these examples. In one example, computer-readable media 50 may be computer-readable storage media 54 or computer-readable signal media 56. Computer-readable storage media 54 may include, for example, an optical or magnetic disk that is inserted or placed into a drive or other device that is part of persistent storage 38 for transfer onto a storage device, such as a hard drive, that is part of persistent storage 38. Computer-readable storage media 54 also may take the form of a persistent storage, such as a hard drive, a thumb drive, or a flash memory, that is connected to data processing system 30. In some instances, computer-readable storage media 54 may not be removable from data processing system 30. In these illustrative examples, computer-readable storage media 54 is a non-transitory computer-readable storage medium.

Alternatively, program code 48 may be transferred to data processing system 30 using computer-readable signal media 56. Computer-readable signal media 56 may be, for example, a propagated data signal containing program code 48. For example, computer-readable signal media 56 may be an electromagnetic signal, an optical signal, and/or any other suitable type of signal. These signals may be transmitted over communications links, such as wireless communications links, optical fiber cable, coaxial cable, a wire, and/or any other suitable type of communications link. In other words, the communications link and/or the connection may be physical and/or wireless in the illustrative examples.

In some embodiments, program code 48 may be downloaded over a network to persistent storage 38 from another device or data processing system through computer-readable signal media 56 for use within data processing system 30. For instance, program code stored in a computer-readable storage medium in a server data processing system may be downloaded over a network from the server to data processing system 30. The data processing system providing program code 48 may be a server computer, a client computer, or some other device capable of storing and transmitting program code 48.

The different components illustrated for data processing system 30 are not meant to provide architectural limitations to the manner in which different embodiments may be implemented. The different advantageous embodiments may be implemented in a data processing system including components in addition to or in place of those illustrated for data processing system 30. Other components shown in FIG. 2 can be varied from the illustrative examples shown. The different embodiments may be implemented using any hardware device or system capable of running program code. As one example, the data processing system may include organic components integrated with inorganic components and/or may be comprised entirely of organic components excluding a human being. For example, a storage device may be comprised of an organic semiconductor.

As another example, a storage device in data processing system 30 may be any hardware apparatus that may store data. Memory 36, persistent storage 38, and computer-readable media 50 are examples of storage devices in a tangible form.

In another example, a bus system may be used to implement communications fabric 32 and may be comprised of one or more buses, such as a system bus or an input/output bus. The bus system may be implemented using any suitable type of architecture that provides for a transfer of data between different components or devices attached to the bus system. Additionally, a communications unit may include one or more devices used to transmit and receive data, such as a modem or a network adapter. Further, a memory may be, for example, memory 36, or a cache such as found in an interface and memory controller hub that may be present in communications fabric 32.

It is understood that all or part of the system(s) and/or method(s) of the present disclosure may be implemented and/or utilized in a cloud computing environment.

As noted above, systems, methods, and computer program products are disclosed herein for telematics systems, such as vehicular navigation systems that display interactive maps, portions of maps, and/or other data.

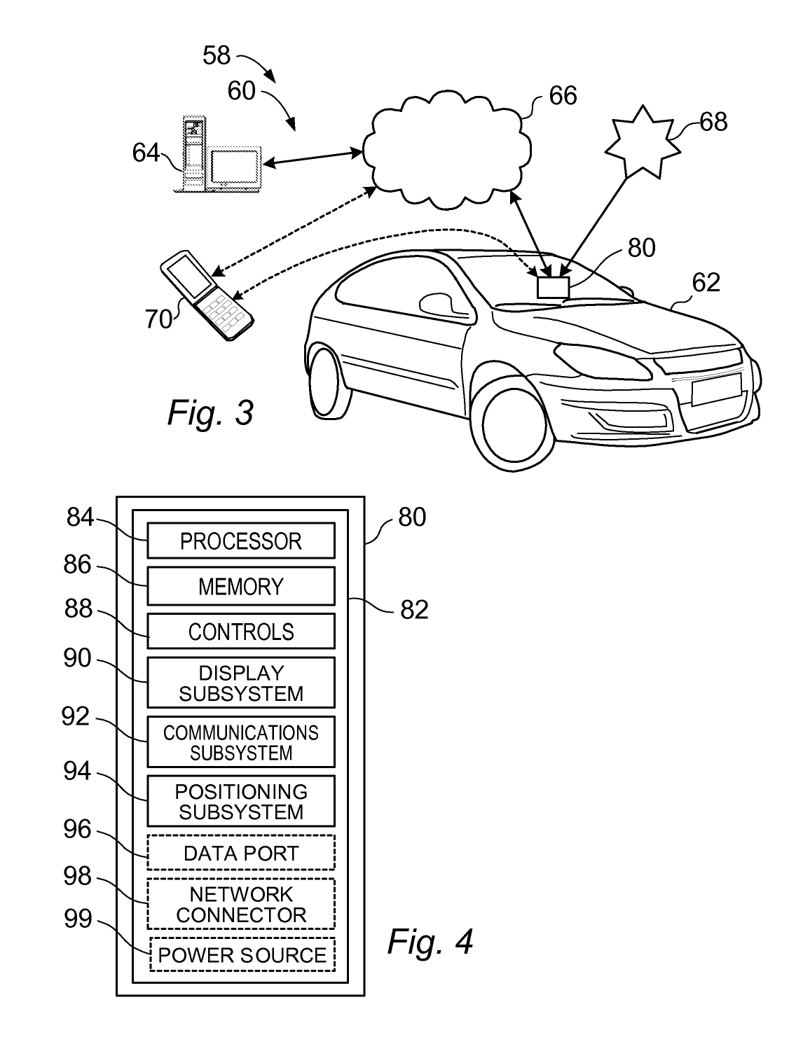

Referring now to FIGS. 3 and 4, a telematics system 58 is a telecommunications and/or data-processing system applicable to mobile devices such as vehicles. Telematics system 58 may be an example of a network data processing system 10 (of FIG. 1) and may sometimes be referred to as a computer system. A system 58 for vehicles may provide features to support navigation, control, communications, and/or entertainment, for example. The navigational aspects of system 58 may provide features to monitor the location of a vehicle, display an interactive map of the territory being crossed, and/or provide directions to a destination, for example. System 58 accordingly may be or may comprise a navigation system 60 and may further comprise other systems not discussed here.

Navigation system 60, which sometimes may be referred to as computer system 60, may comprise one or more vehicles 62, telematics servers 64, telematics networks 66, and positioning systems 68. System 60 may further comprise one or more client computers 70. Computers 70 may be a computer 20, 22, or 24 (of FIG. 1). System 60 may include other, alternative, or additional devices and may omit one or more of the devices listed above. System 60 may be an example of a network data processing system 10 (of FIG. 1).

Vehicle 62 may be any device for transporting persons or things. Accordingly, vehicle 62 may be a mobile structure, often (but not necessarily) self propelled, and often (but not necessarily) wheeled. Examples include automobiles such as cars, trucks, and motorcycles; watercraft such as boats, ships, and barges; towed vehicles such as trailers; bicycles; and aircraft such as airplanes and helicopters. A vehicle 62 may include a telematics unit 80 that may be or may include a navigation unit 82 (of FIG. 4). For brevity and clarity, this disclosure often uses a car as an example of a vehicle 62. The principles disclosed herein are not limited to cars, which simply serve as a familiar, representative example.

Telematics server 64, which may be an example of a server computer 14 or 16 (of FIG. 1) and/or of a data processing system 30 (of FIG. 2), may provide map- and/or account-related services to vehicles 62 in navigation system 60. Map-related services may include storing map data, keeping records of revisions of map data, and/or fulfilling requests to transmit map data, etc. Account-related services may include maintaining a database of users, vehicles 62, telematics unit 80, navigation unit 82, the associations between users, vehicles, and units 80 or 82, the status of units 80 or 82 such as version numbers of stored map data, and/or the status of user accounts such as payment receipt of payment for services.

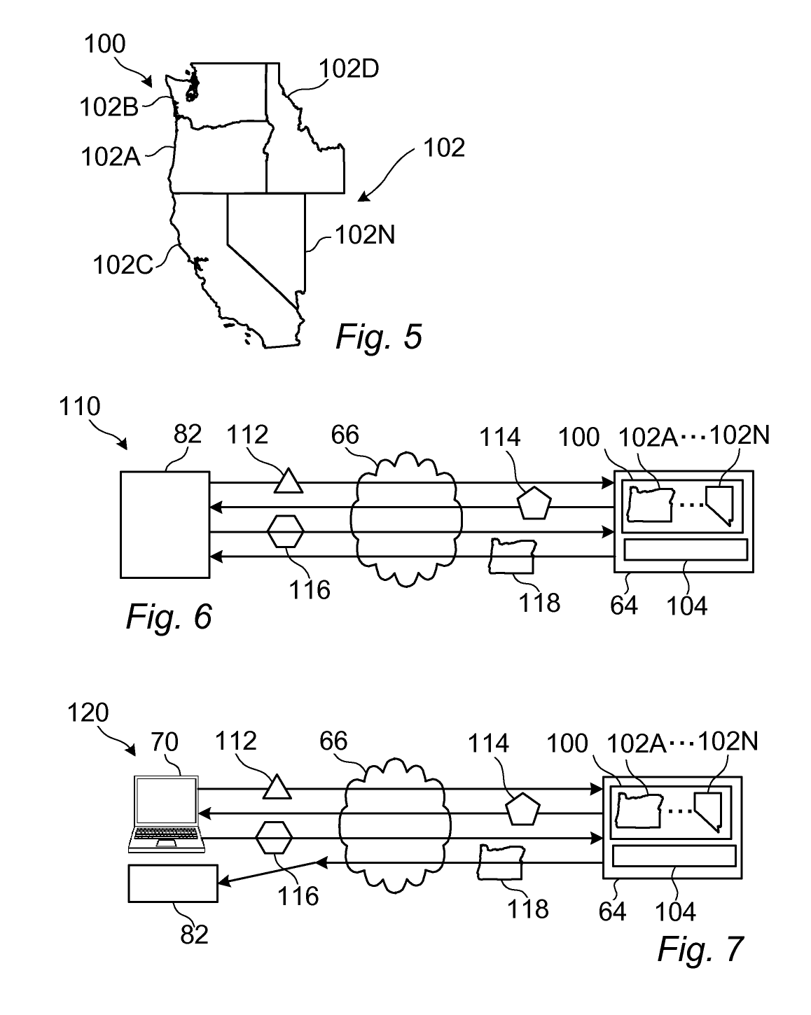

Although FIG. 3 shows a single telematics server 64 performing both map- and account-related tasks, it is understood that these and other tasks may be implemented in other architectures. For example, some or all of the map-data services may be distributed to multiple servers 64, potentially in multiple locations. Some or all of the account services may be distributed to multiple servers, potentially in multiple locations. Some or all of these servers may perform additional tasks. In short, FIG. 5 shows an abstraction of logical functions and is not intended to limit the actual implementation.

The account data stored on server 64 may include a database of one or more users and, for each user, a record of applicable data describing the user and associated devices. The user data may include identifying information such as name, age, gender, and/or a unique user ID (e.g., an account number). Alternatively or in addition, the user data may include home, billing, and/or email addresses, phone numbers, stated options and preferences, subscription data, payment details such as credit card, debit card, and/or bank account numbers and authorizations. Alternatively or in addition, the user data may include payment history, and so on. The data describing devices may include information relating to one or more vehicles 62 and units 80 or 82. Vehicle data may include information such as model, make, color, year, and/or a unique vehicle ID such as vehicle identification number (VIN), etc. Navigation-unit data may include information such as model and version numbers, a unique ID such as a serial number, processor type and version, installed memory, display type, software version numbers, version numbers of stored map data 100, and/or stored portions or packets 102. Alternatively or in addition, the navigation-unit data may include travel history such as routes traversed by unit 82, and so on. Each user, vehicle, and units 80 or 82 may have an associated identifier such as the unique IDs mentioned above. Account data may include records of these identifiers and the associations between identifiers. For example, account data may record the association between a particular user ID, a particular vehicle ID, and a particular unit 80 or 82 identified by serial number.

Telematics network 66, which may be an example of network 12 and which may include the Internet, provides a communications backbone for telematics system 58 and/or navigation system 60. When vehicle 62 is in motion, network 66 may employ one or more wireless communications technologies such as Wi-Fi, cellular-telephone services such as 3G or 4G networks, direct satellite links, and/or terrestrial radio-frequency links. Any of these technologies, alone or in combination, may provide for unidirectional or bidirectional data transfer between vehicle 62, telematics server 64, and other devices of system 58 or 60.

Access to network 66 by vehicle 62 may be intermittent and may depend on local conditions or user choice. If network 66 includes a cellular telephone network, for example, then routes in some areas may be outside the coverage of the cellular network. Even if service is available, a user of vehicle 62 may elect to avoid connecting to network 66 at particular times or places. For example, network 66 may impose fees such as time- or zone-based connection charges, and a user may prefer to minimize or avoid these fees.

When vehicle 62 is not in motion, navigation system 60 may at times directly or indirectly employ a hardwired connection to network 66. For example, if unit 80 or 82 supports a hardwired Ethernet connection, then the user might directly connect unit 80 or 82 to network 66 with an Ethernet cable. For another example, a user may rely on a client computer 70 to obtain map data before taking a trip, and client 70 may employ a hardwired network, a wireless network, or both.

Positioning system 68 may be any device or system capable of determining the location of vehicle 62, such as navigational systems that transmit signals from satellite or terrestrial sources to receivers, or devices that track location by dead reckoning. An example of a satellite-based positioning system is the Global Positioning System (GPS), which employs multiple satellites that broadcast signals containing time and position data. A GPS receiver can use the signals to determine a location. The term “GPS” as used herein is meant to include any satellite-based positioning system. A terrestrial positioning system may employ signals from transmitters that are not orbiting the earth, such as one or more stationary antennas in known locations. Signals from cell-phone towers, for example, can be used to calculate the location of a receiver. A dead-reckoning system may employ inertial navigation and/or sensors built into a vehicle. For example, a compass that measures direction combined with a drive-train sensor that measures distance, may provide position data such as a distance offset from a known starting point. Positioning system 68 may employ more than one technology. For example, positioning system 68 may supplement GPS readings with vehicular sensors, for example, to track location when GPS signals are blocked by tunnels or terrain.

Because GPS and analogous systems rely on signals broadcast from space, FIG. 3 shows positioning system 68 as independent from network 66. In some embodiments, network 66 may be or may share equipment with positioning system 68. A cellular communications network 66, for example, may overlap with a cellular positioning system 68.

Navigation system 60 may further comprise one or more client computers 70, each of which may be an example of client 20, 22, or 24 (of FIG. 1) and/or of a data processing system 30 (of FIG. 2). A client 70 may be a personal computer, smart phone, tablet device, touchpad device, or other device and may be connected to network 66 by a wireless and/or hardwired connection. Client 70 accordingly may communicate via network 66 independently from vehicle 62 with telematics server 64 or other parts of navigation system 60. A user consequently may employ a client 70 to obtain map data from server 64 and subsequently transfer the data to a navigation unit 82 in vehicle 62, for example, via a USB thumb drive. Client 70 accordingly may provide an alternative data-transfer path for use in, for example, locations that do not provide access to a wireless network 66.

Referring now to FIG. 4, a telematics unit 80 may be a telecommunications and/or data-processing device permanently or removably installed in a vehicle 62 to provide features such as navigation, entertainment, vehicle tracking, and/or vehicle control. This application discusses the navigational aspects of telematics unit 80 even though other aspects may be present. Telematics unit 80 may be or may comprise navigation unit 82, and unit 80 may further comprise other elements, systems, or devices. Unit 80 may be an example of a client 20, 22, or 24 (of FIG. 1) and/or of a data processing system 30 (of FIG. 2).

Navigation unit 82 is the portion of telematics unit 80 devoted to in-vehicle navigation. Unit 82 may comprise one or more processors 84, memories 86, controls 88, display subsystems 90, communications subsystems 92, and positioning subsystems 94. Unit 82 may further comprise one or more data ports 96, network connectors 98, and/or power sources 99. Unit 82 may include other, alternative, or additional elements and may omit one or more of the elements listed above. Because a navigation unit 82 may be hosted by a telematics unit 80 that may offer other features, any or all of the resources 84-99 may be provided by telematics unit 80. For instance, a display subsystem 90 may be shared by both the navigation and entertainment portions of telematics unit 80. For brevity, this application describes resources 84-99 as if part of and/or dedicated to unit 82, even though the actual architecture may differ.

Processor 84, which may be an example of a processor unit 34 (of FIG. 2). Processor 84 may provide computational resources for navigation unit 82. Navigation unit 82 (or its host telematics unit 80) accordingly may employ one or more processors 84 to run programs to support the communications, positioning, and/or display subsystems and/or other features. Some subsystems or features may themselves have one or more processors. Positioning subsystem 94, for example, may include a special-purpose processor with a dedicated memory for decoding GPS signals.

Memory 86, which may be an example of a storage device 46 (of FIG. 2) and which may include memory 36 and/or persistent storage 38 (of FIG. 2), provides program and data storage for processor 84. Navigation unit 82 may employ different types of memory for different purposes. For example, unit 82 may employ a relatively fast memory such as RAM for active program instructions and data and employ a slower, persistent memory such as disk storage or flash memory for long-term storage of instructions and data.

Controls 88 may include any feature that allows the user to regulate the operation of navigation unit 82. For example, a control 88 may be a physical switch to turn unit 82 on or off, a keyboard to input alphanumeric data, a touch-screen interface of display subsystem 90, a voice-recognition system programmed to recognize spoken commands, a remote control, and/or other mechanisms, alone or in combination. Unit 82 may provide a user-interface with controls to allow the user to define, for example, the current location of vehicle 62. Alternatively or in addition, unit 82 may provide a user-interface to scroll, resize, or otherwise change the display of a map. Alternatively or in addition, unit 82 may provide a user-interface to request an update of all or part of map data 100 and/or to issue any other commands appropriate to unit 82.

Display subsystem 90 provides a visible output capable of displaying a moving image. Display 90 includes not only a display component such as an LCD or LED panel but also supporting hardware and software. Navigation unit 82 may, for example, rely on GPS position data to identify the current location of vehicle 62 and show a map or portion of a map that includes that location via display 90. Display 90 may further implement controls 88 of unit 82 via display 90, for example, through touch-screen technology.

Communications subsystem 92 may be one or more receivers and/or transmitters that allow navigation unit 82 to connect to network 66. For a moving vehicle 62, communications subsystem 92 may employ a wireless communications link such as Wi-Fi, cellular communications, and/or satellite communications. This connection may be used to communicate with telematics server 64, for example, to request and receive updates to all or part of map data 100. Subsystem 92 may be viewed as a portion of telematics network 66 that travels with vehicle 62.

Positioning subsystem 94 may include one or more receivers, transmitters, and/or sensors used to determine the location of vehicle 62. Positioning subsystem 94 may employ, for example, a GPS receiver to detect signals from GPS satellites to determine the location of the receiver and the vehicle carrying the receiver. Subsystem 94 may employ alternative or additional technology to determine location. Subsystem 94 may update the current location substantially in real time as vehicle 62 travels. Navigation unit 82 may correlate this ongoing current-location data with map data to track the route of vehicle 62 while in motion. For example, unit 82 may correlate the route of vehicle 62 with a road database stored as part of the map data and dynamically indicate the location and route on a dynamic map displayed via display subsystem 90. Subsystem 94 may be viewed as a portion of positioning system 68 that travels with vehicle 62.

Navigation unit 82 may further comprise a data port 96 such as a USB port or SD-card slot. Port 96 may allow the user to transfer data to unit 82. For example, a user may employ a client 70 to download map data 100, portion data 102, software updates, and/or accessory applications, place the data on a USB thumb-drive, plug the USB drive into the data port, and transfer the data to unit 82. The use of a physical medium to transfer data may allow unit 82 to receive data in locations that do not offer a wireless connection, for example. Port 96 may be an example of an input-output unit 42, and USB drives and SD cards may be examples of computer-readable storage media 54.

Navigation unit 82 may further comprise a network connector 98 such as an Ethernet connector. Connector 98 may allow unit 82 to receive send and/or receive data via a hardwired network without relying on a wireless connection, for example, in a location that does not offer wireless communications. Connector 98 may also enable in-vehicle networking with other compatible devices.

Navigation unit 82 may further comprise a power source 99, which may be an automotive battery of vehicle 62, a separate battery provided for unit 82, an array of solar cells, a generator, and/or any other power supply sufficient to operate unit 82. When vehicle 62 is operating, the power source for unit 82 may be the electrical system of vehicle 62, such as an automotive battery kept charged by an alternator. In an embodiment, for example when vehicle 62 is not operating, unit 82 may obtain power from a power source 99, reducing the risk of draining the automotive battery. In an embodiment, unit 82 may be connected to power source 99 and left powered on, for example, to receive transmissions when vehicle 62 is not operating. Client 70 may request a transmission to unit 82, such as when vehicle 62 is not operating, for instance, and power source 99 may allow unit 82 to remain powered on to receive the transmission without draining the automotive battery.

In an embodiment, unit 82 may further comprise one or more client computers 70. For example, client 70 may be a portable computer such as a laptop computer that may operate within vehicle 62. Via data port 96, network connector 98, or other means, client 70 may connect to unit 82 and offer services and/or resources to unit 82. For example, a keyboard or touch screen of client 70 may augment or replace the controls 88 of unit 82. Moreover, a display of client 70 may augment or replace display subsystem 90 of unit 82. Or a processor and memory of client 70 may augment or replace processor 84 and memory of 88 of unit 82. By way of another example, client 70 may be a smart phone with an integral GPS receiver that may augment or replace positioning subsystem 94. Unit 82 accordingly may cooperate with or incorporate a portable client 70.

Referring now to FIG. 5, map data 100 is a digital representation of a territory of interest to users of navigation unit 82 (of FIG. 4). The term “map” as used herein may include any visual or symbolic representation of a territory and/or the relationships among objects, features, and/or elements of that territory. The term “territory” as used herein may include geographic territory (that is, a region of land, air, or water) and more generally may include any space, area, and/or object. Map data 100 may record, encode, or depict natural features such as mountains, lakes, and rivers; area designations such as nations, provinces, states, regions, and cities; routes such as roads, trails, paths, rail lines, and bodies of water; points of interest such as buildings, parks, and historical sites; local events such as festivals and commercial activities; cartographic features such as longitude, latitude, and topographic contours; and any other features of the mapped territory. Data 100 may include one or more labels for any mapped item and may include metadata such as version numbers documenting data 100. Examples of maps include, without limitation, road maps, trail maps, railroad maps, nautical charts, aeronautical charts, and/or topographic maps.

The data-representation techniques used to implement an electronic or digital map may vary and may include storing a database of roads, trails, routes, and the like as one or more vector maps and/or storing significant locations as geographical coordinates. Physical and/or area features in the territory covered by a map may change, for example, as a result of construction or closure of roads within the mapped territory. Changes to the territory and/or correction of errors may trigger revisions to data 100.

Telematics server 64 may store the current, master version of map data 100. Revisions of data 100 may be published by updating the master copy of data 100 on server 64. To keep track of revisions, each revision of data 100 may be assigned a unique identifier or version number, and server 64 may maintain records of these identifiers.

Map data 100 may be divided into at least two portions, which may be referred to as map portions or packets, indicated generally or collectively as 102 and individually as 102A-N. The division into portions may occur by various schemes. For example, each portion 102A-N may correspond to an area or a geographic division of the territory represented by map data 100, such as a state, region, or city. FIG. 5 shows an illustrative example where the territory is a portion of a nation (the western United States) and the divisions are area units (certain states). In another scheme, each portion 102A-N may correspond to a natural feature of the mapped territory. In map data 100 representing a series of lakes, for instance, a portion 102A-N may be assigned to each lake, independent of its area affiliation. In another scheme, each portion 102A-N may correspond to a mathematical, cartographical, or arbitrary division or subdivision. Data 100 may be divided into a coordinate grid such as longitude and latitude, for example, with portions 102A-N identified by coordinates. Data 100 may be divided into portions 102 by more than one scheme.

Map portions 102 may be stored on server 64. Each portion 102 may be dynamically extracted from the superset data 100—that is, generated on the fly, in response to actual requests; or prepared beforehand and stored on server 64; and/or otherwise created and maintained. Each portion 102 may be subject to independent revision. A change to the base map data 100 may impact only portions 102A and 102C, for example, triggering a revision to portions 102A and 102C but not to portions 102B and 102D. Server 64 may maintain the master copy of each portion 102 and may assign a distinct version number to each portion, allowing server 64 to track and transmit portion-specific revisions.

Each portion 102 may be viewed as a map of a portion of the larger territory represented by map data 100. Each portion 102 may be subdivided into second-level portions, and the second-level portions may be subdivided into third-level portions, and so on, up to an indefinite number of levels. Each portion at each level may have its own version number, allowing server 64 to track and transmit portion-specific revisions applicable to portions at any level. “Portion” or “Packet” as used herein may refer to a portion or packet of any level.

In an embodiment, map data 100 and/or the corresponding portions 102 may comprise two or more layers. For example, data 100 and/or portions 102 may have a layer for natural features, a layer for area features, a layer for a road database, and so on. The features in each layer may change at different rates and times and may benefit from updates at different rates and times. Server 64 may assign a distinct version number for each layer, allowing server 64 to track layer-specific revisions. For example, if a user requests an update for a specific portion 102C, a layer-by-layer analysis may show that the layer representing the road database has changed but the layer representing natural features has not changed. Server 64 accordingly may limit the transmission of portion 102C to only the changed layers, reducing the amount of data being transmitted.

In an embodiment, map data 100 and/or portions 102 may have one or more layers that represent temporary features such as festivals and other special events occurring in a territory being traversed. Displaying this information may alert the user to ephemeral attractions. This feature of navigation unit 82 may be streamed into unit 82 in near-real time and correlated to the route being traversed. In an embodiment, transmission of this content may be supported by a subscription fee, by advertising, or both. In an embodiment, temporary features may have associated dates and times, allowing unit 82 to enable or disable the display of time-sensitive content according to its availability.

Navigation unit 82 may store a local copy of all or part of map data 100 and/or all or part of one or more portions 102. A local copy of data 100 may include metadata such as the version number of the local copy. A local copy of each portion 102 may include metadata such as a unique portion identifier that identifies the particular portion, a version number that identifies the revision of that stored portion, an identifier that identifies the superset map data 100 containing the portion, and so on. An initial local copy of data 100 and/or portions 102 may be installed in unit 82 during manufacturing, copied to unit 82 from media shipped with unit 82, downloaded over network 66 and copied to unit 82, or otherwise provided.

The local copy of map data 100 and/or any portion 102 stored by a navigation unit 82 may become out of date with respect to the master copy stored on server 64. To maintain its utility, unit 82 may benefit from obtaining an updated version of data 100 or one or more portions 102. To supply updates, server 64 may transfer an updated copy to unit 82, for example, in response to a request issued by unit 82 or by client 70. In addition, unit 82 may entirely lack map data for some portion of the territory being traversed. For example, unit 82 may have stored map data for some predefined coverage area, and vehicle 62 may go outside the coverage area.

Transferring map data 100 and/or portion data 102 from server 64 to navigation unit 82 may be inconvenient and/or expensive. If vehicle 62 is moving during the data transfer, for example, then the connection to network 66 might be lost during the transfer. If the network 66 includes a cellular network or the like that charges for connect time or for out-of-network service, for example, then the duration and location of the transfer may trigger connection charges or surcharges. If navigation system 60 or portions of system 60 are subscription services, for example, then a data transfer may trigger fees.

Reducing the volume of data being transmitted and/or controlling the timing of the transmission may improve convenience and/or economy when using navigation system 60. Transmitting only portions of map data 100, for example, by allowing the user to select and request specific portions 102 to be updated, may reduce the volume of data to be transmitted, improve the timing of the transmission, or both.

Referring now to FIG. 6, which shows an example of a map-update transaction 110 in an embodiment of the present disclosure, navigation unit 82 may transmit a request for transmission 112 to telematics server 64. In response to request 112, server 64 may send a request for payment 114 to unit 82, which may reply with an indication of payment 116. On receipt of indication 116, server 64 may transmit the requested data such as a map portion 118.

Request for transmission 112 may be a signal conducted by network 66 encoding an automatic or a user-generated request for one or more specified portions 102. Controls 88 of navigation unit 82 or client 70 may provide a means for specifying one or more portions 102 of interest and for initiating request 112. For example, if a user plans to travel to the territory represented by portion 102A (the State of Oregon, in the example of FIG. 5), then unit 82 may provide a means for specifying portion 102A and for sending request 112 to server 64. Request 112 may contain additional data such as a unique identifier associated with unit 82 and the version number of portion 102A stored in unit 82.

On receipt of transmission 112, server 64 may determine whether unit 82 has a current version of the requested portion, for example, by comparing the version number of the portion 102 stored on unit 82 (or recorded in the account data documenting the status of unit 82) with the version number of the master copy stored on server 64. If the version number of the copy stored in unit 82 equals the version number of the master copy on server 64, then unit 82 already has the current version of the requested portion. Server 64 accordingly may transmit an indication that no update is available to unit 82, which may then display an appropriate informative message. If the version of unit 82 predates that of server 64, then server 64 may transmit to unit 82 an indication of available update. Unit 82 may then display an appropriate message, for example, to allow the user to request the available update or cancel the transaction.

If a newer version of portion 102A is available on server 64, server 64 may use the identifier associated with unit 82 to look up account data 104 associated with transmission 112. Updates to maps may be controlled by the terms of a subscription plan or other agreement, for example. Server 64 accordingly may check account data 104 for subscription or payment terms and if appropriate send a payment request 114 to unit 82. In an embodiment, server 64 may transmit a payment request 114 and concurrently or automatically transmit the requested portion 118. Concurrent or automatic transmission may be more efficient, for example, or may be a feature of a subscription plan.

In an embodiment, server 64 may transmit a payment request 114 and wait for an indication of payment 116 before sending the requested map portion 118. Request 114 may detail the requested payment amount and may trigger a user-interface feature such as a message displayed by display subsystem 90, for example, to indicate the amount and provide a means of accepting or refusing payment. For example, account data 104 may include a record of a credit-card number linked to the account, so that the user may select an option to charge the requested payment to the linked credit card. In this embodiment, transmitting the requested portion 118 occurs only after the receipt of an indication of payment of the payment amount.

To report acceptance or refusal, unit 82 may send an indication of payment 116 to server 64. On refusal, server 64 may terminate the transaction without transmitting the requested portion 102. On acceptance, server 64 may perform additional processing such as confirming the validity of the payment with the linked bank, credit-card issuer, or other service provider. After payment is accepted (and, if appropriate, validated), server 64 may transmit the requested portion 118 to unit 82 via network 66. If appropriate, server 64 may update account data 104 and may issue a bill to the user.

The timing of transmission 118 may depend on circumstances such as the availability of a connection to unit 82. This connection may be wireless (for example, when vehicle 62 is in motion) or hardwired (for example, for embodiments of unit 82 that provide a network connector 98). Server 64 may maintain a queue of pending updates associated with the corresponding account data 104 and may wait for unit 82 to connect to network 66 before starting to transmit the pending data. Because the connection to unit 82 may be intermittent, unit 82 may provide storage for partially completed transmissions 118, and server 64 and/or unit 82 may provide mechanisms for keeping track of partially completed transmissions and for continuing a transmission when the connection is restored. On receipt of a complete transmission, unit 82 may replace the old version of the requested portion 102 with the new version and update its local version number. An embodiment of unit 82 may have a power supply 99, for example so that unit 82 may remain powered on to receive updates, for instance when vehicle 62 is not operating.

Referring now to FIG. 7, which shows an example of a map-update transaction 120 in an embodiment of the present disclosure, some steps that involve navigation unit 82 in transaction 110 may instead involve client 70. Client 70 may access (for instance over a web interface) server 64 and/or access and/or run a telematics software application (such as a data manipulation program) provided to interact with server 64, for example, to request updates of map data 100 or portions 102. For updates, the use of client 70 instead of unit 82 may improve speed, reliability, and/or convenience, because client 70 is more likely to be stationary and connected to a faster network. As shown in FIG. 7, in transaction 120, client 70 may issue a request for transmission 112. Server 64 may send messages such as an indication of no update, an indication of available update, and/or a request for payment 114 to client 70. Client 70 may send responses such as an indication of payment 116 to server 64. In the embodiment of FIG. 7, server 64 may transmit the requested data 118 to unit 82, as in transaction 110. In an alternative embodiment (not shown), server 64 may instead transmit the requested data 118 to client 70, where the user may put the data on a USB thumb drive, SD card, or other storage device. For embodiments of unit 82 that offer a data port 96 of the corresponding type, the user may connect the storage device to port 96 to transfer the requested data to unit 82.

A client 70 requesting data 100 or portions 102 on behalf of a unit 82 may become out of sync with respect to the version numbers of the data and portions stored in unit 82. Unit 82 may update a particular portion 102 from a wireless connection, for instance, independent from client 70. The telematics software application of client 70 may provide a feature to allow the user to override version numbers, forcing server 64 to transmit the current version without comparing the version of the master copy in server 64 with the version of the stored copy in unit 82. In an embodiment, server 64 may store a list of portion identifiers and version numbers for each account, independent from the portion identifier and version number data in unit 82 and/or client 70. Each time server 64 transmits a map portion 102 to either unit 82 or client 70, server 64 may store the portion identifier and version number in the associated account record. Unit 82 may report the success of actual updates to server 64. Server 64 may query unit 82 regarding its status including stored portion and version numbers. Server 64 accordingly may synchronize client 70 to the current status of unit 82 and may generally limit transmissions to portions 102 that are out of date in unit 82.

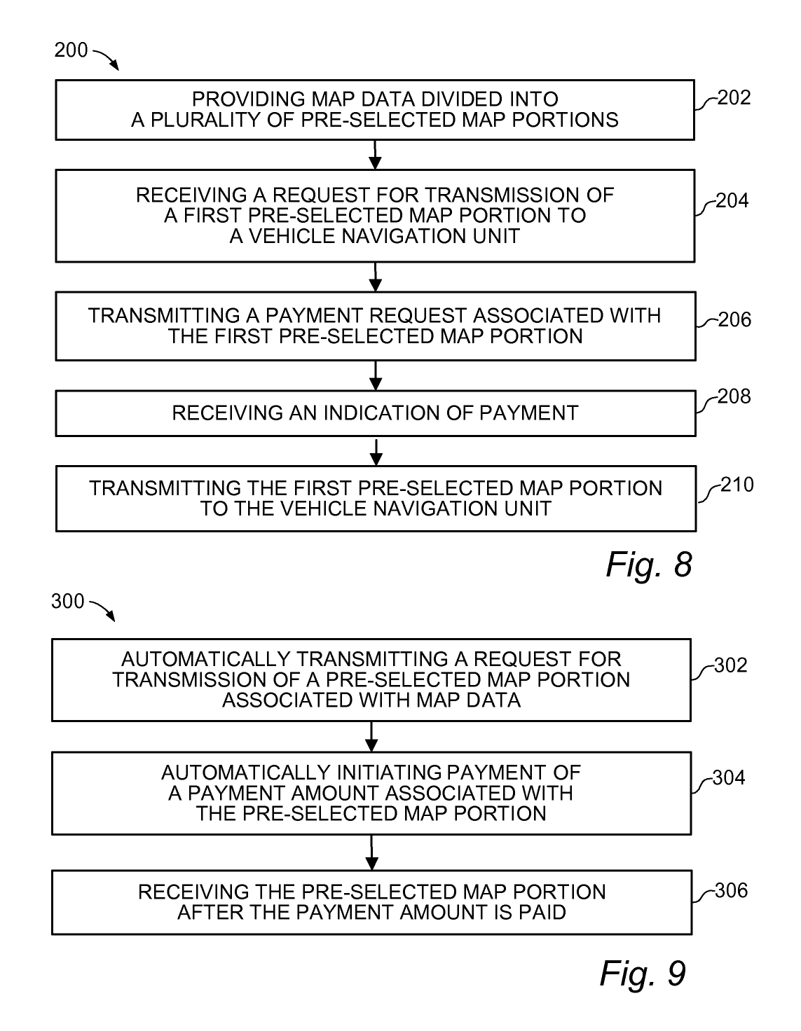

Referring now to FIG. 8, a method 200 implemented in navigation system 60 (also referred to as a computer system) may comprise providing 202 map data divided into a plurality of pre-selected map portions, receiving 204 a request for transmission of a first pre-selected map portion to a vehicle navigation unit, transmitting 206 a payment request associated with the first pre-selected map portion, receiving 208 an indication of payment, and transmitting 210 the first pre-selected map portion to the vehicle navigation unit. Method 200 may include other, alternative, or additional elements. Moreover, method 200 may omit one or more elements and/or may follow a different sequence of elements from that listed. “Pre-selected” data such as portions may sometimes be referred to as “requested” data such as portions.

Providing 202 map data 100 divided into a plurality of pre-selected map portions 102 may include preparing a digital representation of a territory such as (but not limited to) a geographic territory. Providing 202 may further include dividing or subdividing data 100 into at least two different portions 102 according to one or more criteria. Each portion may represent a geographic region or area, for example. The criteria for determining the boundaries of a division or subdivision may include, without limitation, natural features, area boundaries, areas defined by coordinates, or areas defined by arbitrary selection. Providing 202 may further include storing a master copy of data 100 and/or portions 102 on one or more servers 64. Moreover, providing 202 may further include revising data 100 and/or portions 102, for example, to reflect or indicate changes to the territory and/or corrections to the data and/or tracking revisions by a system of version numbers. Providing 202 may include storing an initial local copy of data 100 and/or portions 102 in navigation unit 82, for example, by installing it in unit 82 during manufacturing.

Receiving 204 a request for transmission 112 of a first pre-selected map portion 102 to a vehicle navigation system may include maintaining by server 64 a connection to network 66, waiting for incoming requests 112 addressed to server 64, and detecting incoming requests 112. The sender of a request 112 may be a navigation unit 82 connected to network 66 or a client computer 70 connected to network 66. Receiving 204 may include processing each detected request 112, for example, to obtain from request 112 a unique identifier identifying the sending unit 82 or client 70 and included in request 112, and using that identifier to look up in account data 104 the record for the associated user account. Processing may further include obtaining from request 112 a list of one or more map portions 102 being requested and/or the version numbers of the copies stored in unit 82 (either from the version numbers transmitted in the request 112 or from version numbers stored in the account data for the associated account).

Method 200 may further comprise determining whether unit 82 includes the current version of the pre-selected (that is, requested) map portion. If the version number of the copy stored in unit 82 equals the version number of the master copy stored in server 64, then unit 82 has the current version. If unit 82 already has the current version, method 200 may further comprise transmitting an indication that no update is available to unit 82, which may then display an appropriate informative message. If the version of the stored copy on unit 82 is older than the master copy on server 64, then an update of the requested portion is available. If the portion is absent from unit 82, then an update is available. If an update is available, in an embodiment, method 200 may further comprise transmitting a payment request 114 to unit 82 and concurrently transmitting the requested portion. If an update is available, in an embodiment, method 200 may further comprise transmitting a payment request 114 but not concurrently transmitting the requested portion. This embodiment may, for example, permit unit 82 or client 70 to prompt the user to request the available update or cancel the transaction. In an embodiment, transmitting the first requested portion 118 may occur only after receiving an indication of payment of the payment amount.

If an update is available, receiving 204 may include checking the associated account record in account data 104 to determine if payment is appropriate and, if so, if a request for payment is appropriate. Whether payment is appropriate may depend on the terms of a subscription plan, for example; and whether a payment request 114 is appropriate may depend on user preference, payment history, and/or a threshold amount, for example. If an update is available and payment is unneeded or pre-authorized, then receiving 204 may skip to transmitting 210; otherwise, receiving 204 may proceed to transmitting 206.

Transmitting 206 a payment request 114 associated with the first pre-selected map portion 102 may include generating by server 64 a payment request 114. The content of request 114 may identify, for example, the requested payment amount and identify the requested portion 102, for example, to allow the user to detect and cancel a mistaken or unwanted request. Transmitting 206 may include addressing request 114 to the requesting device (unit 82 or client 70) and sending request 114 to the device via network 66. Transmitting 206 may include maintaining by server 64 a connection to network 66 and waiting to receive a reply such as an indication of payment 116.

On receipt of request 114, the requesting device 82 or 70 may display the content of request 114 and may provide features to allow the user to accept or refuse request 114. On acceptance or refusal, the device may generate an indication of payment 116 indicating acceptance or refusal and send indication 116 via network 66 to server 64. If server 64 does not receive an indication 116, the request 112 may time out after a predetermined time interval. Server 64 may then repeat request 114 or abandon the transaction.

Receiving 208 an indication 116 of payment may include maintaining a connection to network 66 and detecting an incoming indication 116 sent by device 82 or 70 in reply to payment request 114. The detected indication 116 may then be parsed to determine if it indicates acceptance or refusal. Refusal may terminate method 200 without transmission of the requested portion 102. On acceptance, receiving 208 may include confirming the validity of the accepted payment, for example, by electronically billing a credit card or bank account and waiting for confirmation of actual payment. If the payment is invalid, receiving 208 may include generating and sending an informative message to unit 82 or client 70 for display to the user. Responsive to acceptance, refusal, valid payment, or invalid payment, receiving 208 may include updating the associated account record in account data 104. Responsive to acceptance and valid payment (if payment is tested for validity), receiving 208 may advance to transmitting 210.

Transmitting 210 the first pre-selected map portion 102 to the vehicle navigation system may include obtaining or generating the requested map portion 102 (including metadata such as its version number). Moreover, transmitting 210 may include processing portion 102 for transmission, for example, by compressing it and/or converting it to a transmittable format. In addition, transmitting 210 may include placing the portion in a message addressed to the requesting unit 82 or client 70, waiting (if appropriate) for a suitable time to send the message; and transmitting the message containing the requested portion 102 to the requesting device via network 66. The portion, processed for transmission and placed in a transmittable message, may sometimes be referred to as a transmitted map portion 118.

In an embodiment, transmitting 210 a requested portion 118 to unit 82 may include transmitting the requested portion 118 to a telematics unit 80 that includes navigation unit 82.

In an embodiment, requested portion 118 may include a unique identifier associated with telematics unit 80 and/or navigation unit 82. In this way, telematics unit 80 and/or navigation unit 82 may be able to identify that the requested portion 118 is intended to be received by unit 80 and/or unit 82 and may therefore accept receipt of portion 118. For example, if the requested portion 118 is sent over a mobile communications network (e.g., 3G or 4G), then the unique identifier may allow for portion 118 to be identified by unit 80 and/or 82 as the intended recipient of portion 118.

The timing of transmitting 210 may depend on circumstances such as the availability of a connection to unit 82 or client 70. Server 64 may delay transmitting 210 until the requesting unit 82 or client 70 is detected as present on network 66. Alternatively or additionally, server 64 or intermediate servers may compensate for intermittent or occasional connections by unit 82 or client 70, for example, by storing messages including transmitted portions 118 until unit 82 or client 70 connects to network 66 and can receive messages. These mechanisms may be similar to those used by email systems, where intermediate servers may store messages on behalf of devices that intermittently retrieve messages. Because the connection from server 64 to unit 82 or client 70 may be intermittent, server 64, unit 82, and/or client 70 may maintain mechanisms for storing partial transmissions and/or for continuing a transmission when the connection is restored. Transmitting 210 may further include waiting for a completion message from unit 82 (indicating a successful update) and may include updating the account record in account data 104, for example, to record the new, current version number for the portion stored in unit 82.

In an embodiment, transmitting 210 may be performed to update a map, map portion or packet, and/or map data in full or in part of unit 82 or client 70. Telematics system 58 may be configured to transmit data to unit 82 or client 70 only when unit 82 or client 70 is not in active use by a user. For example, data may be transmitted only when unit 82 or client 70 is indicated to be in a “stand-by” or “receiving” mode. In this way, it may be possible to update a map, map portion or packet, and/or map data on unit 82 or client 70 in a plurality of partial transmissions that together form a complete transmission. Transmitting 210 may be configured to occur only when the user is not actively engaged and/or using unit 82 or client 70, e.g., so that transmitting 210 does not interfere with other activities of unit 82 or client 70. For example, unit 82 or client 70 may indicate it is in an “active” mode or “not receiving” mode when the unit 82 or client 70 is in use for other activities such that receiving a transmission is not feasible during that time. For example, transmitting a pre-selected map portion (e.g., from among 102A-N) to the unit 82 may occur after receiving an indication that the unit 82 is in the “receiving” mode. By way of another example, transmitting the first pre-selected map portion to the unit 82 need not or does not occur after receiving an indication that the unit 82 is not in the “receiving” mode.

The system may be configured such that a transmission to unit 82 or client 70 will pause or stop when there is an indication that the system is in an “active” or “not receiving” mode. The system may be configured to re-start transmitting data, resuming or continuing the transmission from the ending-point of the previous partial transmission, when there is an indication that the unit 82 or client 70 is in a “stand-by” or “receiving” mode.

For example, the system may stop transmission after transmitting a partial transmission of a pre-selected map portion (e.g., from among 102A-N) of a complete transmission of the pre-selected map portion when the unit 82 is not in the “receiving” mode. Moreover, the system may re-start a transmission to continue transmitting a remaining portion of the pre-selected map portion of the complete transmission after receiving an indication that the unit 82 is in the “receiving” mode.

Referring now also to FIG. 9, a method 300 implemented in navigation system 60 may comprise automatically transmitting 302 from a first location a request for transmission of a map portion associated with map data for a first geographic region, automatically initiating 304 payment of a payment amount associated with the requested map portion, and receiving 306 the requested map portion after the payment amount is paid. Method 300 may include other, alternative, or additional elements. Moreover, method 300 may omit one or more elements and/or may follow a different sequence of elements from that listed. Method 300 may in general provide an automatic, ongoing update process, for example, by dynamically tracking the location of vehicle 62, automatically testing the currency of the stored map portions 102 corresponding to the territory being traversed, and/or automatically updating any portions that are obsolete or absent.

Automatically transmitting 302 from a first location a request for transmission 112 of a map portion 102 associated with a first geographic region may include specifying or detecting the current location of unit 82, for example, by means of positioning system 68. Moreover, automatically transmitting 302 may include preparing by unit 82 a request for transmission 112 that identifies the location (for example, by reference to the identifier for the portion containing the detected location). In addition, automatically transmitting 302 may include addressing and transmitting request 112 to server 64. For example, the first location may be the location (geometrically, a point) of vehicle 64 at the start of the process, and the requested map portion may be the portion 102 containing that point and the surrounding region (geometrically, an area).

In an embodiment, automatically transmitting 302 may include automatically transmitting from a first location a request for transmission 112 from a telematics unit 60 of a vehicle 62 that includes unit 82. For example, telematics unit 60 need not coincide with navigation unit 82, so that request 112 may originate from another part of unit 60 instead of unit 82.

Server 64 may, on receipt of request 112, determine whether unit 82 has the current version of the selected portion and may reply by transmitting to unit 82 an indication of availability and/or a request for payment 114, as described with reference to method 200. Transmitting 302 accordingly may include maintaining by unit 82 a connection to network 66 so that unit 82 may receive and detect incoming messages from server 64.

In an embodiment, method 300 may further comprise receiving by unit 82 an indication of availability for the portion 102 corresponding to the geographical region of request 112. In an embodiment, unit 82 may display a message to prompt the user to accept or refuse the available update. In an embodiment, unit 82 may automatically accept the available update, so that the update transaction may advance without distracting the user. Whether method 300 seeks or omits confirmation may be a feature of a subscription plan, a preference set by the user, governed by a threshold amount, and/or otherwise predetermined.

Automatically initiating 304 payment of a first payment amount may include detecting an incoming request for payment 114 transmitted by server 64, for example, in response to request 112. In an embodiment, depending on subscription terms, user preference, and/or payment history, initiating 304 may include displaying a message indicating the requested payment amount, an optional description of the selected portion 102, and providing a means for accepting or refusing request 114. In an embodiment, initiating 304 may instead automatically accept the update without user attention or confirmation. This automatic acceptance expedites the process of confirming that all map data for the territory being traversed is current.

Receiving 306 the pre-selected map portion 102 after the payment amount is paid may include maintaining a connection to network 66 and waiting for server 64 to respond to request 114. If the transaction is refused from the server side, for example, as a result of invalid payment, then receiving 306 may include detecting and displaying an informative message issued by server 64 to report transaction status. Otherwise, receiving 306 may include detecting an incoming transmitted map portion 118 and storing the received data. On receipt of a complete transmitted map portion 118, receiving 306 may include extracting the actual map portion 102 from portion 118 (which may contain wrapper and/or address data, employ compression techniques, or otherwise place portion 102 in a transmittable format). Moreover, receiving 306 may include replacing the stored version of the requested portion 102 with the updated version sent by server 64. In addition, receiving 306 may include updating the local version number for the requested portion 102. In an embodiment, unit 82 may send a success message to server 64, for example, to confirm the accuracy of account-specific version data stored there.

In an embodiment, method 300 may further comprise automatically transmitting from a second or subsequent location (a point) a request for transmission 112 for a second or subsequent map portion associated with a second or subsequent geographical region (an area). Vehicle 62, in motion, may initiate an ongoing series of requests 112, for example, at predetermined time intervals, distance intervals, offset distances from the edges of map portions, and/or other events. For example, positioning subsystem 68 may dynamically track the location of vehicle 62 while in motion, allowing unit 82 to send a request for transmission 112 for each map portion associated with each new region being traversed. In an embodiment, software running on server 62, unit 82, or both may attempt to project or predict the route being traversed and may generate requests 112 for portions for one or more predicted regions prior to crossing into the predicted regions. After automatic or manual acceptance of indications of availability and/or requests for payment, and/or after the second or subsequent amount is paid, method 300 may further comprise receiving the second or subsequent requested map portion and updating the stored portion in unit 82 with the current version.

In an embodiment, method 300 may further comprise receiving information to calculate positional coordinates associated with locations, and transmitting 302 a request 112 for transmission when reaching coordinates associated with a first location. Positional coordinates in some embodiments may be latitudinal and longitudinal coordinates. For example, positioning system 68 may dynamically track the location of vehicle 64 while in motion. On reaching specified positional coordinates—in effect, a location that acts as a trigger point—unit 82 may generate and transmit a request 112 for transmission for a portion for the present region, a neighboring region, or a predetermined region. A vehicle 64 approaching a map boundary on a highway, for example, may reach a predetermined location associated with the approaching region (the next region after crossing the boundary). Reaching that location as identified by unique positional coordinates associated with the location may accordingly trigger a request 112 for the map portion for the approaching region, in anticipation of reaching it.

A hardware and/or software program implementing one or more elements of method 200, 300, or both may sometimes be referred to as a “data manipulation program.”

As should be appreciated, the preceding embodiment(s) is/are for illustrative purposes only. In embodiments, steps may be added or removed, and many steps may be performed at least partly in parallel. Different portions of a digital file, or different related digital files may be processed at the same time or prioritized for speed or transfer purposes. Processes such as searching for multiple patterns within arrays may be performed effectively or actually simultaneously. For example some or all processes may be threaded, using a single processor or multiple processors.

The terminology used herein is for the purpose of describing particular embodiments only and is not intended to be limiting of the disclosure. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the disclosure has been presented for purposes of illustration and description, but is not intended to be exhaustive or limited to the embodiments in the form disclosed. Many modifications and variations will be apparent to those of ordinary skill in the art without departing from the scope and spirit of the embodiments of the disclosure. The embodiments were chosen and described in order to best explain the principles of the disclosure and the practical application, and to enable others of ordinary skill in the art to understand the disclosure for various embodiments with various modifications as are suited to the particular use contemplated.

The disclosure can take the form of an entirely hardware embodiment, an entirely software embodiment or an embodiment containing both hardware and software elements. In an embodiment, the disclosure may be implemented in software, which includes but is not limited to firmware, resident software, and/or microcode, etc. Furthermore, the disclosure can take the form of a computer program product accessible from a computer-usable or computer-readable medium providing program code for use by or in connection with a computer or any instruction execution system. For the purposes of this description, a computer-usable or computer-readable medium can be any tangible apparatus that can contain, store, communicate, propagate, and/or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, and pointing devices) can be coupled to the system either directly or through intervening I/O controllers. Network adapters may also be coupled to the system to enable the data processing system to become coupled to other data processing systems or remote printers or storage devices through intervening private or public networks. Modems, cable modem and Ethernet cards are just a few of the currently available types of network adapters.

1. A method, implemented in a computer system, the method comprising:
maintaining, by the computer system, map data divided into at least a first pre-selected map portion and a second pre-selected map portion different from the first pre-selected map portion;
receiving, by the computer system, a request for transmission of the first pre-selected map portion to a vehicle navigation unit;
transmitting, by the computer system, a payment request indicating a payment amount associated with the first pre-selected map portion;
receiving, by the computer system, an indication of payment of the payment amount; and
transmitting, by the computer system, over a wireless network, the first pre-selected map portion to the vehicle navigation unit.

2. The method of claim 1, wherein receiving a request for transmission of the first pre-selected map portion includes receiving the request from the vehicle navigation unit.

3. The method of claim 1, wherein receiving a request for transmission of the first pre-selected map portion includes receiving the request from a second computer system remote from the vehicle navigation unit.

4. The method of claim 1, further comprising determining whether the vehicle navigation unit has a current version of the first pre-selected map portion.

5. The method of claim 4, further comprising:
transmitting, responsive to the vehicle navigation unit having the current version, an indication that no update is available; and
transmitting, responsive to the vehicle navigation unit not having the current version, the payment request and the first pre-selected map portion.

6. The method of claim 4, further comprising transmitting, responsive to the vehicle navigation unit having a prior version of the first pre-selected map portion, an indication that an update is available.

7. The method of claim 1, wherein the first pre-selected map portion includes map data for a first pre-selected geographic region and the second pre-selected map portion includes map data for a second pre-selected geographic region different from the first pre-selected geographic region.

8. The method of claim 1, wherein transmitting the first pre-selected map portion to the vehicle navigation unit only occurs after receiving the indication of payment of the payment amount.

9. The method of claim 1, wherein transmitting the first pre-selected map portion to the vehicle navigation unit further includes transmitting a unique identifier associated with the vehicle navigation unit to allow for identification of the first pre-selected map portion by the vehicle navigation unit receiving the first pre-selected map portion.

10. The method of claim 1, wherein transmitting the first pre-selected map portion to the vehicle navigation unit includes transmitting the first pre-selected map portion to a telematics unit of a vehicle that includes the vehicle navigation unit.

11. The method of claim 1, wherein transmitting the first pre-selected map portion to the vehicle navigation unit includes transmitting over a mobile communications network the first pre-selected map portion to the vehicle navigation unit, the vehicle navigation unit being enabled to communicate over the mobile communications network.

12. A system for updating electronic maps, comprising:
a first computer system including:
a first processor;
a first memory; and
a first data manipulation program including a plurality of instructions stored in the first memory that when executed by the first processor, cause the first processor to:
provide map data divided into at least a first pre-selected map portion and a second pre-selected map portion different from the first pre-selected map portion;
receive a request for transmission of the first pre-selected map portion;
transmit a payment request indicating a payment amount associated with the first pre-selected map portion;
receive an indication of payment of the payment amount; and
transmit the first pre-selected map portion;
a second computer system, remote from the first computer system, including:
a second processor;
a second memory; and
a second data manipulation program including a plurality of instructions stored in the second memory that when executed by the processor, cause the second processor to:
transmit to the first computer system the request for transmission of the first pre-selected map portion; and
transmit to the first computer system the payment amount in response to the payment request; and
a vehicle navigation unit including:
a third processor;
a third memory; and
a third data manipulation program including instructions stored in the third memory that when executed by the third processor, cause the third processor to receive the transmission of the first pre-selected map portion from the first computer system.

13. The system of claim 12, wherein the vehicle navigation unit is connected to a power source and powered on to receive transmissions on-demand from the first computer system.

14. The system of claim 12, further comprising a telematics unit disposed in a vehicle, the telematics unit including the vehicle navigation unit.

15. The system of claim 12, wherein the vehicle navigation unit includes the second computer system.

16. A method, implemented in a vehicle navigation system, the method comprising:
automatically transmitting from a first location a request for transmission of a first pre-selected map portion associated with map data for a first geographic region;
automatically initiating payment of a first payment amount associated with the first pre-selected map portion; and
receiving the first pre-selected map portion after the first payment amount is paid.

17. The method of claim 16, further comprising receiving an indication that an update is available of the map data for the first geographic region.

18. The method of claim 16, further comprising:
automatically transmitting from a second location a request for transmission of a second pre-selected map portion associated with map data for a second geographic region different from the first geographic region; and
receiving the second pre-selected map portion after a second payment amount is paid associated with the second pre-selected map portion.

19. The method of claim 16, further comprising receiving information to calculate one or more unique positional coordinates associated with the first location, wherein automatically transmitting the request occurs based on reaching the one or more unique positional coordinates associated with the first location.

20. The method of claim 16, wherein automatically transmitting from a first location a request for transmission of a first pre-selected map portion associated with map data for a first geographic region includes automatically transmitting from a telematics unit of a vehicle that includes a vehicle navigation unit of the vehicle navigation system.

21. The method of claim 1, wherein transmitting the first pre-selected map portion to the vehicle navigation unit occurs after receiving an indication that the vehicle navigation unit is in a receiving mode.

22. The method of claim 21, wherein transmitting the first pre-selected map portion to the vehicle navigation unit does not occur after receiving an indication that the vehicle navigation unit is not in a receiving mode.

23. The method of claim 22, further comprising:
stopping a transmission after transmitting a partial transmission of the first pre-selected map portion of a complete transmission of the first pre-selected map portion when the vehicle navigation unit is not in the receiving mode; and
re-starting a transmission to continue transmitting a remaining portion of the first pre-selected map portion of the complete transmission after receiving an indication that the vehicle navigation unit is in the receiving mode.
